(19) United States
(12) Patent Application Publication
(10) Pub. No.: US 2008/0219120 A1
(43) Pub. Date: Sep. 11, 2008

(54) Method and System to Improve Playability of Optical Record Medium

(75) Inventor: Nicolas Decerf, Walhain (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,491

(22) PCT Filed: Sep. 28, 2006
(86) PCT No.: PCT/IB2006/053542

§ 371 Date: Mar. 28, 2008

(30) Foreign Application Priority Data
Sep. 29, 2005 (EP) 05108984.5

(51) Int. Cl. G11B 5/58

(52) U.S. Cl. 369/53.17

(57) ABSTRACT

In summary, when an optical record medium is to be played, the optical drive first determines which type of optical record medium is inserted based on detection of a few signals and execution of a few calibrations. These calibrations could fail sometimes, making the optical record medium completely unrecognisable or converging to bad settings, thereby decreasing the playability of the optical record medium. This problem is solved by using a new criterion to calibrate the optical drive and improve the playability of the optical record medium, which comprises analyzing the header information. This method is useful in all optical drive systems such as CD, DVD and blu-ray players.

The present invention relates to a method for measuring a quality factor to determine a quality of reading of an optical record medium.

The invention further relates to an optical record player arranged to use the method for measuring a quality factor to determine a quality of reading of an optical record medium.

The invention further relates to a system for measuring a quality factor to determine a quality of reading of an optical record medium.

The invention further relates to an optical record player comprising the system for measuring a quality factor to determine quality of reading of an optical record medium.

JP07073480 discloses a method for reading ATIP (Absolute time in pre-groove) information with less error rate when reading data from an optical record medium. The method reads ATIP information and outputs an offset control signal. Based on the output-offset signal, the actuator is displaced, ATIP information is read again and the error rate in read ATIP information is checked. By repeating this process, an optimum offset amount is obtained which is the offset where the number of error data in ATIP is the least. By using this method it is possible to read ATIP information with less error rate. This method allows recording of information and reading ATIP information with less error rate but, has no effect on the playability of the optical record medium. It is to be noted that the optical record medium may suffer from defects such as scratches, fingerprints, dust etc. As a result, the playability of such optical record medium decreases and also the servo operation may get affected to such an extent that the radiation beam looses the track and/or focus. In such cases, fixed settings of an optical drive can cause playability problems and hence calibrations are needed. While reading such optical record media, the optical drive may choose bad settings. This will result in decreasing the playability of the optical record medium thereby creating video playback and file corruption errors. The method disclosed in JP07073480 does not improve the playability of such optical record medium.

The object of the invention is to improve the playability of an optical record medium. This object is achieved by providing a method for measuring a quality factor to determine quality of reading of an optical record medium. The measurement of quality factor involves analyzing header information. The measured quality factor is an indication of quality of reading of the optical record medium. Further the quality factor is used to calibrate the settings of the optical drive that is used to read the optical record medium. By doing so, the calibrated settings improve the playability of the optical record medium. Choosing the right settings reduces video playback and file corruption errors. The method for measuring the quality factor comprises the steps of:

reading header information from the optical record medium,

measuring at least one parameter of the read header information,

computing the quality factor from at least one measured parameter.

In an embodiment of the method according to the invention, the method comprises considering a number of header information so that the method ensures a stable calibration. The method comprises performing a plurality of iterations of the step of:

reading header information from the optical record medium,

measuring at least one parameter of the read header information,

computing an intermediate quality factor from at least one measured parameter,

and computing the quality factor by averaging the intermediate quality factor obtained on a plurality of iterations.

In a second embodiment of the method according to the invention, the method comprises measuring more than one parameter of the read header information. This allows obtaining two different quality factors which can be used to determine the quality of reading of the optical record medium.

In a further embodiment of the method, the method further comprises:

measuring a first parameter and a second parameter of the read header information,

computing the quality factor by using both the measured first parameter and the measured second parameter.

In a still further embodiment of the method according to the invention, the method comprises considering a number of header information and measuring the quality factor so that the method ensures a stable calibration. The method comprises performing a plurality of iterations of the step of:

reading header information from the optical record medium,

measuring a first parameter and a second parameter of the read header information,

computing an intermediate quality factor by using both the measured first parameter and the measured second parameter,

and computing the quality factor by averaging the intermediate quality factor obtained on a plurality of iterations.

In an advantageous embodiment, the method can further comprise generating an interrupt once the header information is read. The generation of interrupt helps in notifying that header information is read and hence measurement of parameter from the read header information can be carried out.

The header information that is read from the optical record medium can be time information multiplexed with stream of data. By reading this header information, the optical drive will know which part of the optical record medium is accessed.

In an embodiment of the invention, the method further comprises using at least one weight factor of the measured parameter to compute the quality factor. By having a weight factor, it is possible to obtain a quality factor that varies between a minimum value and a maximum value.

A good parameter to use for the measured first parameter is an indicator whether the header information is correctable.

A good parameter to use for the measured second parameter is the number of errors that have been corrected for each of the read header information.

In a further embodiment of the method according to the invention, the method further comprises using the computed quality factor to calibrate the settings of the optical drive to improve the playability of the optical record medium. By calibrating, it is possible to select the right settings of the optical drive and thereby improve the playability of the optical record medium. This reduces video playback and file corruption errors.

Further, the method of measuring the quality factor to determine quality of reading of an optical record medium as described in the embodiments can be used by an optical record player such as a CD player, a DVD player or a Blu-ray disc player.

The object of the invention is achieved by providing a system for measuring a quality factor to determine quality of reading of an optical record medium, the system comprising:

means arranged to read header information from the optical record medium,

means arranged to measure at least one parameter of the read header information,

means arranged to compute the quality factor from at least one measured parameter.

In an embodiment, the system further comprises means arranged to perform a plurality of iterations of the step of:

reading header information from the optical record medium,

measuring at least one parameter of the read header information,

computing an intermediate quality factor from at least one measured parameter,

and means arranged to compute the quality factor by averaging the intermediate quality factor obtained on a plurality of iterations.

In an other embodiment of the system, the system further comprises means arranged to measure more than one parameter of the read header information.

In a further embodiment of the system, the system further comprises:

means arranged to measure a first parameter and a second parameter of the read header information,

means arranged to compute the quality factor by using both the measured first parameter and the measured second parameter.

In an embodiment of the system, the system further comprises means arranged to perform a plurality of iterations of the step of:

reading header information from the optical record medium,

measuring a first parameter and a second parameter of the read header information,

computing an intermediate quality factor by using both the measured first parameter and the measured second parameter,

and means arranged to compute the quality factor by averaging the intermediate quality factor obtained on a plurality of iterations.

In an advantageous embodiment, the system further comprises means arranged to generate an interrupt once the header information is read to initiate measuring of at least one parameter.

The system can further comprise means arranged to use at least one weight factor of the measured parameter to compute the quality factor.

In a second embodiment of the system according to the invention, the system further comprises calibration means arranged to calibrate the settings of the optical drive using the computed quality factor.

Further, the system for measuring a quality factor to determine quality of reading of an optical record medium can be used in an optical record player for measuring the quality factor to determine quality of reading of the optical record medium.

It is to be noted that the object of the invention is achieved by providing a method and a system for improving playability of the optical record medium wherein the system has the same advantages as the methods.

These and other aspects of the invention will be apparent from the embodiments described in the following description and with reference to the accompanying drawings in which,

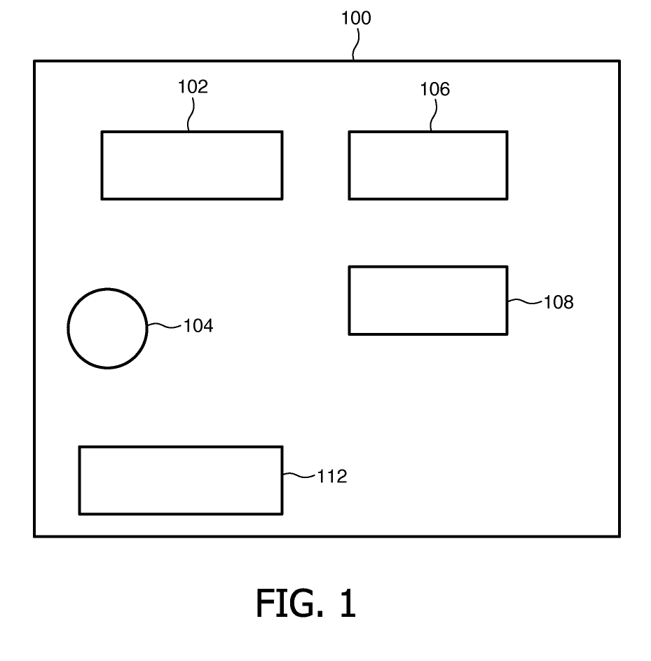

FIG. 1 shows a first embodiment of the system for measuring a quality factor to determine quality of reading an optical record medium according to the invention,

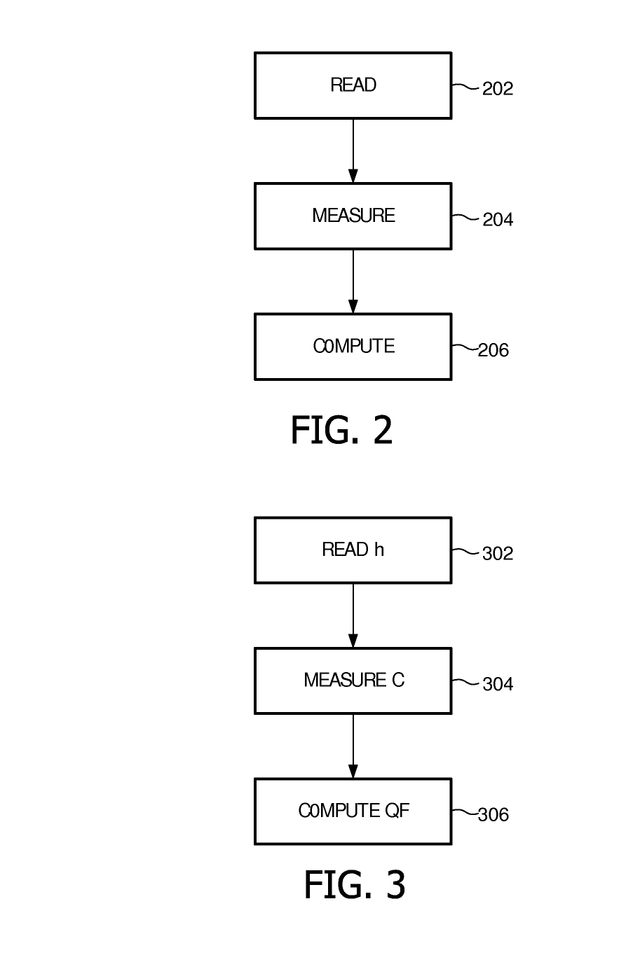

FIG. 2 shows a simplified flowchart illustrating the method of measuring the quality factor to determine quality of reading an optical record medium according to the invention,

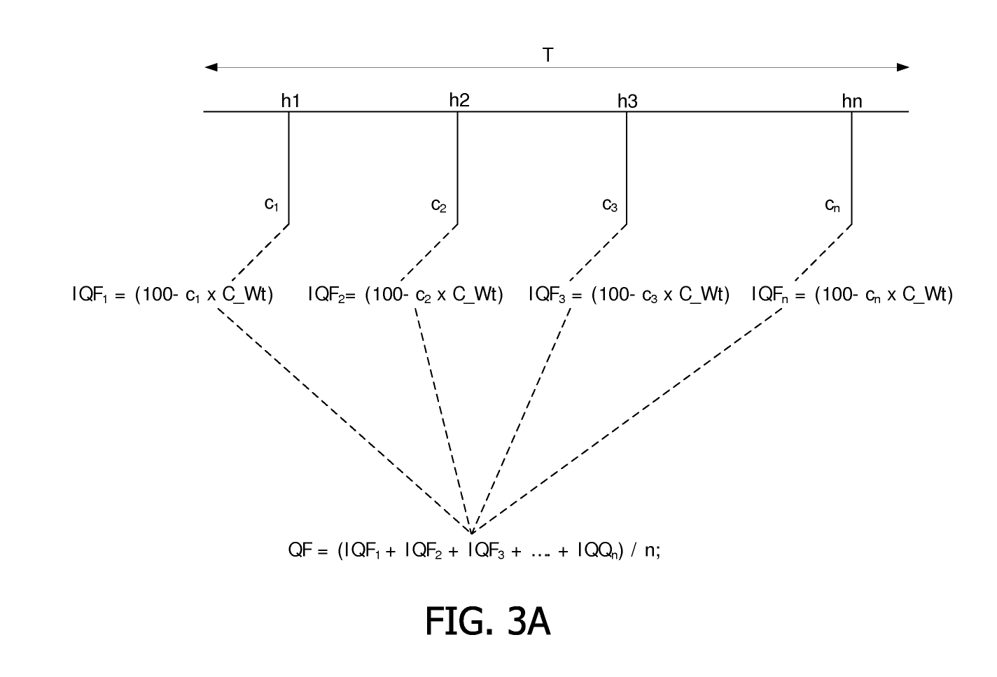

FIG. 3 shows a first embodiment of the method according to the invention,

FIG. 3A shows an other embodiment of the method according to the invention,

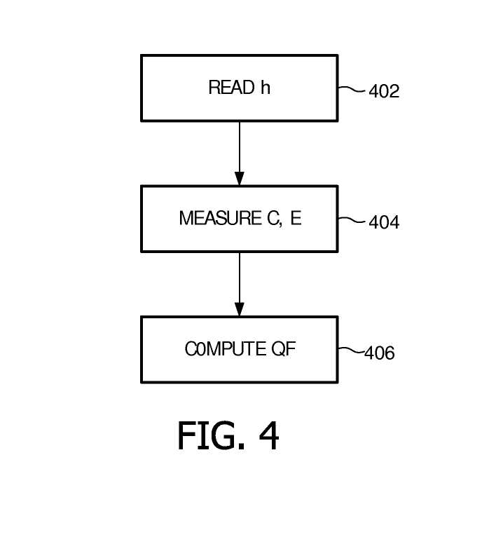

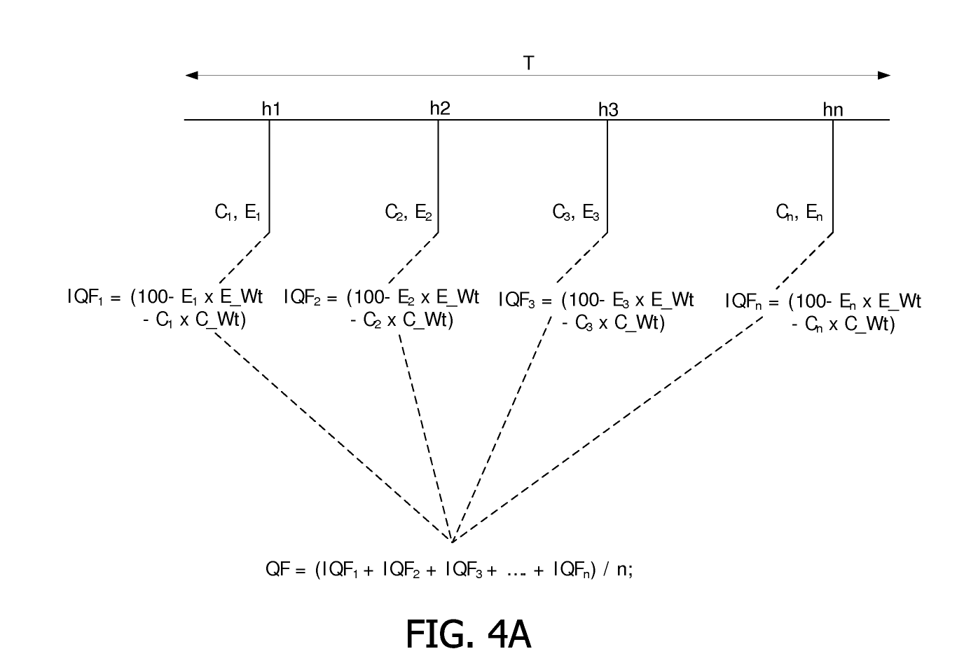

FIG. 4 shows a second embodiment of the method according to the invention,

FIG. 4A shows an other embodiment of the method according to the invention,

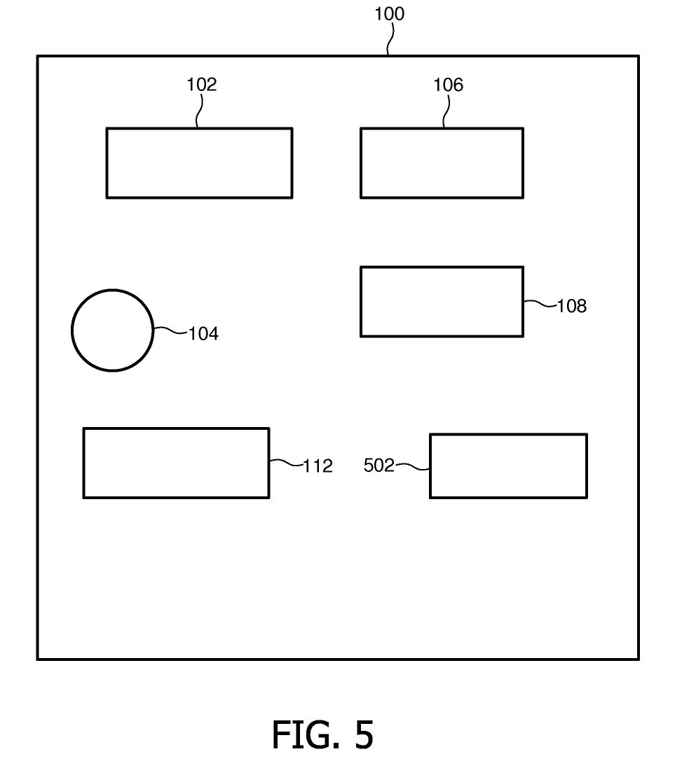

FIG. 5 shows a second embodiment of the system according to the invention.

FIG. 1 shows a first embodiment of the system 100 for measuring a quality factor to determine quality of reading an optical record medium 104 according to the invention. It should be noted that optical record medium are produced in many flavours as read only types (CD-DA, DVD-Video, DVD-ROM) write once recordable types (CD-R, DVD-R, DVD+R) and rewritable types (CD-RW, DVD-RW, DVD+RW). The present invention is applicable in relation to all the above-mentioned types and also the newly developed Blu-Ray discs. Since such optical record media is known per se, a detailed explanation is omitted here. It should be noted that such optical record media have at least one record track, either in the shape of a continuous spiral or in the shape of multiple concentric circles, in which data is pre recorded during the manufacturing for read only media or can be written by the user for recordable and rewritable media. In a first embodiment of the system 100, the system comprises a reading means 102 arranged to read header information from the optical record medium 104. This header information is time information multiplexed with stream of data. The system 100 comprises an interrupt generating means 112 arranged to generate an interrupt once the header information is read by the reading means 102. The interrupt can be a hardware interrupt or a software interrupt. The system 100 comprises measurement means 106 arranged to measure at least one parameter of the read header information. Further, the system 100 comprises computing means 108 arranged to compute the quality factor based on at least one measured parameter. The computing means 108 is further arranged to use at least one weight factor of the measured parameter to compute the quality factor. The reading means 102 is a part of the optical recording/reproducing mechanism comprising the following which is implicit and hence not shown in FIG. 1.

i. An optical drive mechanism for rotating the optical record medium 104. The optical drive mechanism comprising a spindle motor which serves as a revolving unit for revolving the optical record medium 104. A motor driver and a servo-processing unit to control the spindle motor so as to provide a constant linear velocity or constant angular velocity.
ii. A radiation source for generating a radiation beam.
iii. An optics system for converging the radiation beam from the radiation source for irradiating the optical record medium 104.
iv. Radiation receiving means for receiving the reflected radiation beam from the optical record medium 104 and reading the tracks of the optical record medium 104.
v. An actuator to focus the radiation beam onto the optical record medium 104 and a positioning means for coarse and fine positioning of the radiation beam. Further, the servo-processing unit controls the actuator position such as focus, radial and tilt.

Further, the system 100 is able to perform a plurality of iterations of reading header information from the optical record medium 104 using the reading means 102 and measuring at least one parameter in each iteration using the measurement means 106. Further, the computing means 108 comprises means arranged to compute the intermediate quality factor from the measured parameter and compute the quality factor as an average of the intermediate quality factor obtained on a plurality of iterations.

In an other embodiment of the system 100 as shown in FIG. 1, the measurement means 106 is arranged to measure more than one parameter of the read header information. The measurement means 106 measures a first parameter and a second parameter of the read header information. The computing means 108 is arranged to compute the quality factor by using both the measured first parameter and the measured second parameter. Further, the system 100 is able to perform a plurality of iterations of reading header information from the optical record medium 104 using the reading means 102 and measuring the first parameter and second parameter in each iteration using the measurement means 106. Further, the computing means 108 comprises a means arranged to compute an intermediate quality factor by using both the measured first parameter and the measured second parameter. Further the computing means 108 computes the quality factor by averaging the intermediate quality factor obtained on a plurality of iterations.

FIG. 2 shows a simplified flowchart illustrating the method of measuring the quality factor to determine quality of reading of an optical record medium 104 (See FIG. 1) according to the invention. The method comprises reading header information from the optical record medium 104 (See FIG. 1) using the reading means 102 (See FIG. 1) in step 202. In step 204, using the measurement means 106 (See FIG. 1) measuring at least one parameter of the read header information. In step 206, using the computing means 108 (See FIG. 1) and computing the quality factor from at least one measured parameter.

FIG. 3 shows a first embodiment of the method according to the invention, the method comprising measuring Corfail flag C of the read header information to determine quality of reading of the optical record medium 104 (See FIG. 1). The optical record medium 104 is a recorded medium, i.e., a medium with data recorded thereon, and hence the read header information also contains data. In FIG. 3, header information h is read from the optical record medium 104 by the reading means 102 (See FIG. 1) in step 302. Once the header information is read by the reading means 102 (See FIG. 1) an interrupt is generated by the interrupt generating means 112 (See FIG. 1). This interrupt can be for example an hardware interrupt which is generated by an optical channel decoder or a software interrupt. This interrupt helps in notifying that header information is read and hence measurement of Corfail flag C from the read header information is carried out. This Corfail flag C of the header information is measured by the measurement means 106 (See FIG. 1) in step 304. The measured Corfail flag C represents whether the read header information is correctable or not. A value of zero means that the header information is not correctable and is of low quality. On the other hand, a value of one means that the header information is correctable and the header information is of high quality. After having measured Corfail flag C of the read header information, in step 306 the computing means 108 (See FIG. 1) computes the quality factor as

Quality factor=(100−C×Corfail weight)

By selecting the Corfail weight as 100, you obtain a quality factor, which varies from 0 to 100 and is a predictive measure of seek quality. This seek quality measure gives the quality of accessing a defined position on the optical record medium 104.

FIG. 3A shows an other embodiment of the method according to the invention. In FIG. 3A, a plurality of header information {h₁, h₂, h₃, . . . hₙ} is read from the optical record medium 104 by the reading means 102 (See FIG. 1) during a time interval T. Each time the header information is read by the reading means 102 (See FIG. 1) an interrupt is generated by the interrupt generating means 112 (See FIG. 1). This interrupt helps in notifying that header information is read and hence measurement of the parameter Corfail flag {C₁, C₂, C₃, . . . Cₙ} from the read header information {h₁, h₂, h₃, . . . hₙ} is carried out. For example, we may have one interrupt that is generated for every sector. At start up (at 40 Hz) it may result in 1200 headers, wherein 30 headers correspond to one disc revolution. For each of the header information read, the parameter namely Corfail flag C of the read header information is measured by the measurement means 106 (See FIG. 1) and an intermediate quality factor is computed as

(Intermediate quality factor)ᵢ=(100−Cᵢ×Corfail weight), where i takes value from 1 to n

The quality factor is computed by averaging the intermediate quality factor on all the n read header information.

Quality factor=(Σ(Intermediate Quality factor)ᵢ)/n, for i going from 1 to n.

By selecting the Corfail weight as 100, you obtain a quality factor, which varies from 0 to 100 and is a predictive measure of seek quality. This seek quality measure gives the quality of accessing a defined position on the optical record medium 104.

FIG. 4 shows a second embodiment of the method according to the invention. The method comprises measuring a first parameter and a second parameter of the read header information and computing the quality factor by using both the measured first parameter and the measured second parameter. In FIG. 4, header information h is read from the optical record medium 104 by the reading means 102 (See FIG. 1) in step 402. Once the header information is read by the reading means 102 (See FIG. 1) an interrupt is generated by the interrupt generating means 112 (See FIG. 1). This interrupt helps in notifying that header information is read and hence measurement of the first parameter and the second parameter from the read header information is carried out. For the header information read, the first parameter namely Corfail flag C and the second parameter namely NbrErrors E is measured by the measurement means 106 (See FIG. 1) in step 404. The measured parameter Corfail flag C represents whether the read header information is correctable or not. A value of zero means that the header information is not correctable and is of low quality. On the other hand, a value of one means that the header information is correctable and the header information is of high quality. The measured second parameter NbrErrors E represents the number of errors that have been corrected for the read header information. The second parameter NbrErrors E takes a minimum value of zero, which represents highest quality of the read header information and a maximum value of 5, which represents that the header information is of low quality. After having measured the first parameter Corfail flag C and the second parameter NbrErrors E of the read header information, in step 406 the computing means 108 (See FIG. 1) computes the quality factor as

Quality factor=(100−E×Error Weight−C×Corfail weight)

By selecting the Error weight as 10 and Corfail weight as 50, you obtain a quality factor, which varies from 0 to 100 taking the error information into consideration. This quality factor gives a measure of playability of the optical record medium 104.

FIG. 4A shows an other embodiment of the method according to the invention. In FIG. 4A, a plurality of header information {h₁, h₂, h₃, . . . hₙ} is read from the optical record medium 104 by the reading means 102 (See FIG. 1) during a time interval T. Each time the header information is read by the reading means 102 (See FIG. 1) an interrupt is generated by the interrupt generating means 112 (See FIG. 1). This interrupt helps in notifying that header information is read and hence measurement of the first parameter Corfail flag {C₁, C₂, C₃, . . . Cₙ} and the second parameter NbrErrors {E₁, E₂, E₃, . . . Eₙ} from the read header information {h₁, h₂, h₃, . . . hₙ} is carried out. For example, we may have one interrupt that is generated for every sector. At start up (at 40 Hz) it may result in 1200 headers, wherein 30 headers correspond to one disc revolution. For each of the header information read, the first parameter Corfail flag C and the second parameter NbrErrors E is measured by the measurement means 106 (See FIG. 1) and an intermediate quality factor is computed as

(Intermediate quality factor)ᵢ=(100−Eᵢ×Error Weight−Cᵢ×Corfail Weight)

Where i takes value from 1 to n,

The quality factor is computed by averaging the intermediate quality factor on all the n measures, where the maximum is 100 and the minimum depends on the two weight factors namely Error weight and Corfail weight.

Quality factor=(Σ(Intermediate Quality factor)ᵢ)/n, for i going from 1 to n.

By selecting the Error weight as 10 and Corfail weight as 50, you obtain a quality factor, which varies from 0 to 100 taking the error information into consideration. This quality factor gives a measure of playability of the optical record medium 104. On the other hand, by selecting the Error weight as 0 and Corfail weight as 100, you obtain a quality factor, which varies from 0 to 100 without taking the error information into consideration. This quality factor gives a measure of seek quality. This seek quality measure gives the quality of accessing a defined position on the optical record medium 104.

FIG. 5 shows a second embodiment of the system 100 according to the invention for measuring a quality factor to determine quality of reading an optical record medium 104. In FIG. 5, the elements that have the same construction as in FIG. 1 have been designated by the same reference numeral and are not explained in detail. The system 100 as shown in FIG. 5 further comprises a calibration means 502 arranged to calibrate the settings of the optical drive using the computed quality factor. In the embodiments described above, using the system 100, a quality factor is computed for the optical record medium 104 (See FIG. 1) using the method as described in the embodiments (See FIG. 3, FIG. 3A, FIG. 4, FIG. 4A). This computed quality factor is used by the calibration means 502 to calibrate the settings of the optical drive that is used to rotate the optical record medium 104. By calibrating the settings of the optical drive, the playability of the optical record medium 104 is improved. This allows improving the playability of the optical record medium 104 by calibrating different factors. Some of the factors such as: focus offset, tilt offset, K level of the limit equaliser and clip level of the limit equaliser are successively readjusted. After calibrating these settings, with the readjusted settings the playability of the optical record medium 104 (See FIG. 1) improves.

The method of measuring quality factor as described in the embodiments can be used by any optical record player or a disc player like a CD player, a DVD player or a Blu-ray disc player. The method measures the quality factor and calibrates the settings of the optical drive like the CD drive, DVD drive or a blu-ray drive, so that the playability of the optical record medium is improved. Especially, it is possible to enhance the playability for various kinds of optical record media by appropriately selecting the settings that enables stable playback when certain defects are there on the optical record medium. The method works well on bad optical record media and play mode is not necessary. In general, it is useful for optical disc systems and optical disc audio/video players and computer drives.

The order in the described embodiments of the method of measuring a quality factor to determine a quality of reading of an optical record medium is not mandatory, a person skilled in the art may change the order of steps without departing from the concept as intended by the present invention. Further, in the claims any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the system claims enumerating several means, several of these means can be embodied by one and the same item of computer readable software or hardware. A person skilled in the art may change the order or the means to get the same effect as intended by the present invention. Further, in the foregoing application, the invention has been described with reference to specific embodiments thereof. It will however be evident that various modifications and changes may be made without departing from the broader scope of the invention, as set forth is the appended claims. The figures and description are accordingly, to be regarded for illustrative purposes than being used in the restrictive sense.

1. A method for measuring a quality factor to determine a quality of reading of an optical record medium comprising the steps of
reading header information from the optical record medium,
measuring at least one parameter of the read header information,
computing the quality factor from at least one measured parameter.

2. A method as claimed in claim 1, the method further comprising performing a plurality of iterations of the step of
reading header information from the optical record medium,
measuring at least one parameter of the read header information,
computing an intermediate quality factor from at least one measured parameter,
and wherein the quality factor is computed by averaging the intermediate quality factor obtained on a plurality of iterations.

3. A method as claimed in claim 1, the method comprising measuring more than one parameter of the read header information.

4. A method as claimed in claim 3, the method further comprising:
measuring a first parameter and a second parameter of the read header information,
computing the quality factor by using both the measured first parameter and the measured second parameter.

5. A method as claimed in claim 4, the method further comprising performing a plurality of iterations of the step of
reading header information from the optical record medium,
measuring a first parameter and a second parameter of the read header information,
computing an intermediate quality factor by using both the measured first parameter and the measured second parameter,
and wherein the quality factor is computed by averaging the intermediate quality factor obtained on a plurality of iterations.

6. A method as claimed in claim 1, the method further comprising generating an interrupt once the header information is read to initiate measuring of at least one parameter.

7. A method as claimed in claim 1, wherein the header information is time information multiplexed with stream of data.

8. A method as claimed in claim 1, the method comprising using at least one weight factor of the measured parameter to compute the quality factor.

9. A method as claimed in claim 4, wherein the measured first parameter indicates whether the read header information is correctable.

10. A method as claimed in claim 4, wherein the measured second parameter indicates the number of errors that have been corrected for each of the read header information.

11. A method as claimed in claim 1, the method further comprising using the computed quality factor to calibrate the settings of the optical drive to improve the readability of the optical record medium.

12. An optical record player arranged to use one of the methods as claimed in claim 1.

13. A system for measuring a quality factor to determine a quality of reading of an optical record medium comprising:
means arranged to read header information from the optical record medium,
means arranged to measure at least one parameter of the read header information,
means arranged to compute the quality factor from at least one measured parameter.

14. A system as claimed in claim 13, the system further comprising means arranged to perform a plurality of iterations of the step of
reading header information from the optical record medium,
measuring at least one parameter of the read header information,
computing an intermediate quality factor from at least one measured parameter,
and means arranged to compute the quality factor by averaging the intermediate quality factor obtained on a plurality of iterations.

15. A system as claimed in claim 13, the system comprising means arranged to measure more than one parameter of the read header information.

16. A system as claimed in claim 13, the system comprising
means arranged to measure a first parameter and a second parameter of the read header information,
means arranged to compute the quality factor by using both the measured first parameter and the measured second parameter.

17. A system as claimed in claim 13, the system comprising means arranged to perform a plurality of iterations of the step of
reading header information from the optical record medium,
measuring a first parameter and a second parameter of the read header information,
computing an intermediate quality factor by using both the measured first parameter and the measured second parameter,
and means arranged to compute the quality factor by averaging the intermediate quality factor obtained on a plurality of iterations.

18. A system as claimed in claim 13, the system further comprising means arranged to generate an interrupt once the header information is read to initiate measuring of at least one parameter.

19. A system as claimed in claim 13, the system comprising means arranged to use at least one weight factor of the measured parameter to compute the quality factor.

20. A system as claimed in claim 13, the system comprising calibration means arranged to calibrate the settings of the optical drive using the computed quality factor.

21. An optical record player comprising a system for measuring a quality factor to determine quality of reading of the optical record medium as claimed in claim 13.
